(19) United States
(12) Patent Application Publication
(10) Pub. No.: US 2007/0188490 A1
(43) Pub. Date: Aug. 16, 2007

(54) Apparatus, method and program for segmentation of mesh model data into analytic surfaces based on robust curvature estimation and region growing

(75) Inventors: Satoshi Kanai, Sapporo-shi (JP); Takeshi Kishinami, Sapporo-shi (JP); Tomohiro Mizoguchi, Sapporo-shi (JP); Hiroaki Date, Sapporo-shi (JP)

Correspondence Address: NDQ&M WATCHSTONE LLP, 1300 EYE STREET, NW, SUITE 1000 WEST TOWER, WASHINGTON, DC, 20005, US

(73) Assignee: National University Corporation Hokkaido University, Sapporo-shi (JP)

(21) Appl. No.: 11/393,714

(22) Filed: Mar. 31, 2006

(30) Foreign Application Priority Data
Feb. 13, 2006 (JP) 2006-035719

(51) Int. Cl. G06T 17/20

(52) U.S. Cl. 345/423

(57) ABSTRACT

An apparatus, a method and a program segment mesh model data into analytic surfaces based on robust curvature estimation and region growing by extracting, from mesh model data, analytic surface regions (planar, cylindrical, conical, spherical and toric surface regions) and by automatically recognizing fillet surface regions, linear-extrusion surface regions and surface regions of revolution from the extracted regions and edges. The apparatus, method and program input mesh model data, find sharp vertices in the mesh model data, calculate principal curvatures at each non-sharp vertex, create, from the calculated principal curvatures, seed regions each being considered to belong to an analytic surface region and including a set of linked vertices, extract analytic surface regions by growing the seed regions, recognize fillet surface regions, linear-extrusion surface regions and surface regions of revolution in the extracted analytic surface regions, and output information concerning the extracted analytic surface regions and information concerning the recognized regions.

### CORRESPONDING PATENT APPLICATION

This application is based upon and claims the benefit of priority from the prior Japanese Patent Application No. 2006-035719 which was filed on Feb. 13, 2006.

### BACKGROUND OF THE INVENTION

1. Field of the Invention

The present invention relates to an apparatus, a method and a program for segmentation of mesh model data into analytic surfaces based on robust curvature estimation and region growing.

2. Description of Related Art

3D laser scanning systems are widely used in the field of reverse engineering to acquire geometric point cloud data from real-world products. More recently, high energy X-ray scanning systems have been rapidly developed, and they are used to acquire 3D image data of complex engineering parts with inner structures quickly and non-destructively. To use the acquired scanned data in today's digital engineering, it is easily converted into a 3D mesh model by a well known surface reconstruction algorithm such as marching cubes [1]. When 3D scanned mesh model is utilized for repairing, replication, analysis, or inspection of engineering parts, it is necessary to efficiently segment the mesh model into desirable regions depending on its applications.

The surfaces of engineering parts mainly consist of a set of analytic surfaces, such as planes, cylinders, spheres, cones and tori. Therefore, it is necessary to extract regions where each can be closely approximated by a simple analytic surface from a mesh model. This segmentation or extraction enables the feature recognition from mesh models, and it plays an important pre-process for parametric mesh deformation, mesh smoothing, FEM mesh generation and solid model creation.

Many methods have been proposed to extract regions which are separated by sharp edges, or each of which can be approximated by a single free form surface patch. However, few methods have been proposed to extract regions each of which can be approximated by an analytic surface from a mesh model. Moreover, in these methods, the accuracies of extracting regions from noisy mesh models and the range of extracted analytic surface classes were not necessarily sufficient from the aspect of practical engineering use.

Related works are as follows. Mesh curvature estimation is one of the essential techniques used in many mesh applications, such as mesh segmentation, mesh feature extraction and re-meshing. Therefore a variety of approaches have been proposed [5], [6] and [7]. As Razdan mentioned in his work [5], mesh curvature estimations are roughly divided into two groups. One is to estimate curvatures by formulating a closed form for differential geometry operators on the discrete representation (discrete), and the other is to first locally fit a relatively high ordered surface around each mesh vertex and to estimate curvatures by analyzing this surface (continuous). As reported in the past works [3], [4] and [5], the latter estimation provides better results for noisy mesh models.

Mesh segmentation is a technique that partitions a mesh model into desirable regions depending on applications, and many approaches have been proposed for this segmentation. The mesh segmentation is roughly divided into three groups:

The first group is to extract regions separated by sharp edges on a mesh model. In this group, a watershed-based approach has been well studied [8], [9] and [10]. This watershed algorithm was first proposed for 2D image segmentation, and Mangan et al. [8] extended it into mesh segmentation. In this watershed algorithm, a feature value such as mesh curvature for each vertex is allocated and local minima of curvatures are found. Then neighboring vertices around each local minima are clustered using a steepest descent algorithm, and sharp edges appear at the boundary between two clusters. Sun et al. [9] improved the algorithm using a more robust vertex feature value calculation for noisy scanned meshes. Razdan et al. [10] improved the algorithm for a mesh tessellated from a solid model. These methods can segment a mesh model into regions separated by sharp edges. However they cannot extract regions separated by smooth edges (i.e., a region consisting of a plane smoothly connected to a cylinder), and therefore cannot correctly identify the surface geometry of each segmented region.

The second group is to extract regions each of which can be approximated by a simple free form surface. In this group, a region growing approach [3], [11] and [12] has been studied. The region growing method was first proposed by Besl et al. [11] for height field data. Recently Vieira et al. [3] extend this method into 3D noisy mesh models by a laser scanner. This algorithm first estimates mesh curvatures and creates seed regions using the sign of mesh curvatures. Then it iteratively fits free form surfaces and adds neighboring vertices to the regions for extracting final regions. This method can extract free form surface regions from noisy mesh models, and can separately extract smoothly blended surfaces. However the method did not focus on extracting regions approximated by analytic surfaces and their geometric parameters.

The last group is to extract regions each of which can be approximated by a simple analytic surface. Gelfand et al. [13] proposed a method based on eigenvalue analysis of mesh vertices and their normal vector. However this method only extracts regions which can be approximated by planes, cylinders and spheres. Wu et al. [14] proposed a method based on Lloyd's clustering algorithm. In their method, in addition to the three surfaces, the fillet regions approximated by a rolling ball along free form curves can be extracted. However they did not discuss how well the method works for a noisy mesh model, and how they specify initial regions of segmentation. Moreover the processing time is relatively slow due to the iteration of surface fitting and clustering. Benko et al. [4] proposed the direct segmentation method for reverse engineering of the engineering part. Their algorithm first discards triangles in the vicinity of sharp edges by locally fitting a plane, and divides the input mesh into regions. Next, geometric compatibility between triangles and underlying surfaces are tested for each regions based on a variety of indicators, such as normal vectors or principal curvatures. Thus regions are extracted which can be approximated by simple analytic surfaces (planes, cylinders, spheres, cones, tori), linear sweep surfaces and the surface of revolutions. However this algorithm can result in poor segmentation near boundaries of surfaces where the indicators in mesh models may not be properly estimated. They applied their segmentation only for a simple mesh model with very simple geometry.

### REFERENCES

[1] Lorensen, W. E., Harvey, E. C.: Marching cubes: A high resolution 3D surface construction algorithm. ACM SIGGRAPH Computer Graphics, Vol. 21, No. 4. (1987) 163-169

[2] Benko, P., Martin, R., Várady, T.: Algorithms for reverse engineering boundary representation models. Computer Aided Design, Vol. 33, No. 11. (2001) 839-851

[3] Vieira, M., Shimada, K.: Surface mesh segmentation and smooth surface extraction through. Computer-Aided Geometric Design, Vol. 22, No. 8. (2005) 771-792

[4] Benko, P., Várady, T.: Segmentation methods for smooth point regions of conventional engineering objects. Computer-Aided Design, Vol. 36, No. 6. (2004) 511-523

[5] Razdan, A., Bae, M. S.: Curvature estimation scheme for triangle meshes using biquadratic Béezier patches. Computer-Aided Design, Vol. 37, No. 14. (2005) 1481-1491

[6] Meyer, M., Desbrun, M., Schröder, P., Barr, A. H.: Discrete Differential-Geometry Operators for Triangulated 2-Manifolds. Proc. of Visualization and Mathematics, Vol. 3. (2002) 34-57

[7] Steiner, C. D., Morvan, J. M.: Restricted Delaunay triangulations and normal cycle. Proc. of the nineteenth annual symposium on computational geometry. (2003) 312-321

[8] Mangan, A. P., Whitaker, R. T.: Partitioning 3D Surface Meshes Using Watershed Segmentation. IEEE Transaction on visualization and computer graphics, Vol. 5, No. 4. (1999) 308-321

[9] Sun, Y. D., Page, L., Paik, J. K., Koschan, A., Abidi, M. A.: Triangle mesh-based edge detection and its application to surface segmentation and adaptive surface smoothing. Proc. of the International Conference on Image Processing. Vol. 3. (2002) 825-828

[10] Razdan, A.: Hybrid approach to feature segmentation of triangle meshes. Computer-Aided Design, Vol. 35, No. 9. (2003) 783-789

[11] Besl, P. J., Jain, R. C.: Segmentation through Variable-Order Surface Fitting. IEEE Transactions on Pattern Analysis and Machine Intelligence. Vol. 10, No. 2. (1988) 167-192

[12] Djebali, M. Melkemi, M., Sapidis, N.: Range-Image segmentation and model reconstruction based on a fit-and-merge strategy. Proc. of ACM symposium on Solid modeling and applications. (2002) 127-138

[13] Gelfand, N., Guibas, L. J.: Shape segmentation using local slippage analysis. Proc. of Eurographics/ACM SIGGRAPH symposium on Geometry processing. (2004) 214-223 Wu, J., Kobbelt, L.: Structure Recovery via Hybrid Variational Surface Approximation. Proc. of Eurographics. Vol. 24, No. 3. (2005) 277-284

[14] Lloyd, S.: Least square quantization in PCM. IEEE Transactions on Information Theory. Vol. 28. (1982) 129-137

[15] Kós, G., Martin, R., Várady, T.: Methods to recover constant radius rolling blends in reverse engineering. Computer-Aided Geometric Design. Vol. 17, No. 2. (2000) 127-160

[16] Benko, P., Kós, G., Várady, T., Andor, L., Martin, R.: Constrained fitting in reverse engineering. Computer-Aided Geometric Design. Vol. 19, No. 3. (2002) 173-205

[17] Marshall, D., Lukacs, G., Martin, R.: Robust Segmentation of Primitives from Range Data in the Presence of Geometric Degeneracy. IEEE Transactions on Pattern Analysis and Machine Intelligence. Vol. 23, No. 3. (2001) 304-314

[18] Zhu, H., Menq, C. H.: B-Rep model simplification by automatic fillet/round suppressing for efficient automatic feature recognition. Computer-Aided Design. Vol. 34, No. 2. (2002) 109-123

[19] Japanese Unexamined Patent Application Publication No. Hei-9-311951

[20] Japanese Unexamined Patent Application Publication No. 2001-325304

[21] Japanese Unexamined Patent Application Publication No. 2004-272820

[22] Japanese Unexamined Patent Application Publication No. 2005-327041

### SUMMARY OF THE INVENTION

An object of the present invention is to provide an apparatus, a method and a program for segmentation of mesh model data into analytic surfaces based on robust curvature estimation and region growing that segments mesh model data into regions where each can be approximated by a simple analytic surface. The present invention employs an accurate mesh curvature estimation based on recognition of sharp edges on a noisy mesh model. Combining this accurate curvature estimation with the non-iterative region growing enables to find more accurate boundaries between underlying analytic surfaces. Moreover, the present invention can extract higher-level classes of surfaces (fillet surfaces, linear extrusion surfaces and surfaces of revolution) from the analytic surfaces by categorizing neighboring relations of surfaces and by grouping them.

In order to accomplish the objects, a first aspect of the present invention provides an apparatus for segmentation of mesh model data into analytic surfaces, including an input unit configured to input mesh model data; a principal curvature calculator configured to find, in the mesh model data, sharp vertices each having a principal curvature (maximum principal curvature) greater than a threshold, exclude the sharp vertices, and calculate principal curvatures at each non-sharp vertex in the mesh model data; a seed region creator configured to create, from the calculated principal curvatures, seed regions each being considered to belong to an analytic surface region and including a set of linked vertices; a surface fitting unit configured to determine, for each of the created seed regions, geometric parameters that define an analytic surface region according to the vertices of the seed region and fit the analytic surface region to the seed region; a analytic surface region extractor configured to determine, for each of the created seed regions, whether or not each vertex that is in the vicinity of the seed region has allowable errors relative to the position and normal of the surface fitted to the seed region, add the vertex to the seed region if the vertex has allowable errors to thereby grow the seed region, and extract an analytic surface region representative of the grown seed region; a surface region recognizer configured to recognize fillet surface regions, linear-extrusion surface regions and surface regions of revolution in the extracted analytic surface regions; and a data output unit configured to output information of the extracted analytic surface regions and the recognized regions.

According to the first aspect of the present invention, the principal curvature calculator sets a parameter for determining a curvature evaluating range of each vertex twice as large as an average length of edges connected to the vertex, calculates principal curvatures at the vertex, classifies the vertex as a sharp vertex if a maximum principal curvature thereof is greater than the threshold, sets a parameter for determining a curvature evaluating range of each non-sharp vertex five times as large as an average length of edges connected to the non-sharp vertex, and calculates principal curvatures at the non-sharp vertex.

According to the first aspect of the present invention, the seed region creator includes a vertex labeling unit configured to examine the principal curvatures of each vertex calculated by the principal curvature calculator and assign to the vertex a label indicative of one selected from the group consisting of a plane surface, a cylindrical surface, a conical surface, a spherical surface and an optional surface to which the vertex belongs; and a seed region extractor configured to extract, as a seed region, a set of linked vertices having the same label assigned by the vertex labeling unit.

According to the first aspect of the present invention, the vertex labeling unit prepares, for vertices to which the optional surface label is assigned, a histogram with an abscissa representing principal curvatures and an ordinate representing the numbers of vertices and assigns a toric surface label to a group of vertices which have a predetermined principal curvature and whose number is greater than a threshold on the histogram.

According to the first aspect of the present invention, when fitting any one of a cylindrical surface and a conical surface to a seed region, the surface fitting unit fits a plane to intersections between normals at vertices contained in the seed region and a Gaussian sphere and determines a normal of the plane as a direction of an axis. For the cylindrical surface, the surface fitting unit projects the vertices contained in the seed region to a plane that has a normal in the axis direction and crosses an origin, fits a circular arc to the projected vertices, and finds a center of the circular arc and an arbitrary point on the axis. For the conical surface which satisfies a condition that a vector connecting the apex of the conical surface to each mesh vertex is orthogonal to a normal at the mesh vertex, the surface fitting unit calculates the apex of the conical surface according to the least square method and finds an apex angle according to an average of angles between the axis direction and the normals at the mesh vertices.

According to the first aspect of the present invention, when fitting a toric surface to a seed region, the surface fitting unit finds a direction of an axis and an arbitrary point on the axis, and according to the axis direction and arbitrary point, uses the least square method to calculate a center c, major radius R and minor radius r of the toric surface on condition that a minor-radius center c′ is found by inwardly extending normals at mesh vertices for the minor radius r and the major radius R is found as a distance between the center c and the minor-radius center c′.

A second aspect of the present invention provides a method for segmentation of mesh model data into analytic surfaces, including inputting mesh model data; finding, in the mesh model data, sharp vertices each having a principal curvature (maximum principal curvature) greater than a threshold, excluding the sharp vertices, and calculating principal curvatures at each non-sharp vertex in the mesh model data; creating, from the calculated principal curvatures, seed regions each being considered to belong to an analytic surface region and including a set of linked vertices; determining, for each of the created seed regions, geometric parameters that define an analytic surface region according to the vertices of the seed region and fitting the analytic surface region to the seed region; determining, for each of the created seed regions, whether or not each vertex that is in the vicinity of the seed region has allowable errors relative to the position and normal of the surface fitted to the seed region, adding the vertex to the seed region if the vertex has allowable errors to thereby grow the seed region, and extracting an analytic surface region representative of the grown seed region; recognizing fillet surface regions, linear-extrusion surface regions and surface regions of revolution in the extracted analytic surface regions; and outputting information concerning the extracted analytic surface regions and the recognized regions.

According to the second aspect of the present invention, finding sharp vertices and calculating principal curvatures include setting a parameter for determining a curvature evaluating range of each vertex twice as large as an average length of edges connected to the vertex, calculating principal curvatures at the vertex, classifying the vertex as a sharp vertex if a maximum principal curvature thereof is greater than the threshold, setting a parameter for determining a curvature evaluating range of each non-sharp vertex five times as large as an average length of edges connected to the non-sharp vertex, and calculating principal curvatures at the non-sharp vertex.

According to the second aspect of the present invention, creating seed regions includes examining the calculated principal curvatures of each vertex, assigning to the vertex a label indicative of one selected from the group consisting of a plane surface, a cylindrical surface, a conical surface, a spherical surface and an optional surface to which the vertex belongs, and extracting, as a seed region, a set of linked vertices having the same assigned label.

The method according to the second aspect of the present invention may further include preparing, for vertices to which the optional surface label is assigned, a histogram with an abscissa representing principal curvatures and an ordinate representing the numbers of vertices and assigning a toric surface label to a group of vertices which have a predetermined principal curvature and whose number is greater than a threshold on the histogram.

According to the second aspect of the present invention, determining geometric parameters that define an analytic surface region and fitting the analytic surface region include, when fitting any one of a cylindrical surface and a conical surface to a seed region, fitting a plane to intersections between normals at vertices contained in the seed region and a Gaussian sphere and determining a normal of the plane as a direction of an axis; for the cylindrical surface, projecting the vertices contained in the seed region to a plane that has a normal in the axis direction and crosses an origin, fitting a circular arc to the projected vertices, and finding a center of the circular arc and an arbitrary point on the axis; and for the conical surface which satisfies a condition that a vector connecting the apex of the conical surface to each mesh vertex is orthogonal to a normal at the mesh vertex, calculating the apex of the conical surface according to the least square method and finding an apex angle according to an average of angles between the axis direction and the normals at the mesh vertices.

According to the second aspect of the present invention, determining geometric parameters that define an analytic surface region and fitting the analytic surface region include, when fitting a toric surface to a seed region, finding a direction of an axis and an arbitrary point on the axis, and according to the axis direction and arbitrary point, using the least square method to calculate a center c, major radius R and minor radius r of the toric surface on condition that a minor-radius center c′ is found by inwardly extending normals at mesh vertices for the minor radius r and the major radius R is found as a distance between the center c and the minor-radius center c′.

A third aspect of the present invention provides a computer executable program for segmentation of mesh model data into analytic surfaces, including inputting mesh model data; finding, in the mesh model data, sharp vertices each having a principal curvature (maximum principal curvature) greater than a threshold, excluding the sharp vertices, and calculating principal curvatures at each non-sharp vertex in the mesh model data; creating, from the calculated principal curvatures, seed regions each being considered to belong to an analytic surface region and including a set of linked vertices; determining, for each of the created seed regions, geometric parameters that define an analytic surface region according to the vertices of the seed region and fitting the analytic surface region to the seed region; determining, for each of the created seed regions, whether or not each vertex that is in the vicinity of the seed region has allowable errors relative to the position and normal of the surface fitted to the seed region, adding the vertex to the seed region if the vertex has allowable errors to thereby grow the seed region, and extracting an analytic surface region representative of the grown seed region; recognizing fillet surface regions, linear-extrusion surface regions and surface regions of revolution in the extracted analytic surface regions; and outputting information concerning the extracted analytic surface regions and the recognized regions.

According to the third aspect of the present invention, finding sharp vertices and calculating principal curvatures include setting a parameter for determining a curvature evaluating range of each vertex twice as large as an average length of edges connected to the vertex, calculating principal curvatures at the vertex, classifying the vertex as a sharp vertex if a maximum principal curvature thereof is greater than the threshold, setting a parameter for determining a curvature evaluating range of each non-sharp vertex five times as large as an average length of edges connected to the non-sharp vertex, and calculating principal curvatures at the non-sharp vertex.

According to the third aspect of the present invention, creating seed regions includes examining the calculated principal curvatures of each vertex, assigning to the vertex a label indicative of one selected from the group consisting of a plane surface, a cylindrical surface, a conical surface, a spherical surface and an optional surface to which the vertex belongs, and extracting, as a seed region, a set of linked vertices having the same assigned label.

The computer executable program according to the third aspect of the present invention may include preparing, for vertices to which the optional surface label is assigned, a histogram with an abscissa representing principal curvatures and an ordinate representing the numbers of vertices and assigning a toric surface label to a group of vertices which have a predetermined principal curvature and whose number is greater than a threshold on the histogram.

According to the third aspect of the present invention, determining geometric parameters that define an analytic surface region and fitting the analytic surface region include, when fitting any one of a cylindrical surface and a conical surface to a seed region, fitting a plane to intersections between normals at vertices contained in the seed region and a Gaussian sphere and determining a normal of the plane as a direction of an axis; for the cylindrical surface, projecting the vertices contained in the seed region to a plane that has a normal in the axis direction and crosses an origin, fitting a circular arc to the projected vertices, and finding a center of the circular arc and an arbitrary point on the axis; and for the conical surface which satisfies a condition that a vector connecting the apex of the conical surface to each mesh vertex is orthogonal to a normal at the mesh vertex, calculating the apex of the conical surface according to the least square method and finding an apex angle according to an average of angles between the axis direction and the normals at the mesh vertices.

According to the third aspect of the present invention, determining geometric parameters that define an analytic surface region and fitting the analytic surface region include, when fitting a toric surface to a seed region, finding a direction of an axis and an arbitrary point on the axis, and according to the axis direction and arbitrary point, using the least square method to calculate a center c, major radius R and minor radius r of the toric surface on condition that a minor-radius center c′ is found by inwardly extending normals at mesh vertices for the minor radius r and the major radius R is found as a distance between the center c and the minor-radius center c′.

As mentioned above, each of the apparatus, method and program according to the present invention for segmentation of mesh model data into analytic surfaces inputs mesh model data, finds, in the mesh model data, sharp vertices each having a principal curvature (maximum principal curvature) greater than a threshold, excludes the sharp vertices, calculates principal curvatures at each non-sharp vertex in the mesh model data, creates, from the calculated principal curvatures, seed regions each being considered to belong to an analytic surface region and including a set of linked vertices, determines, for each of the created seed regions, geometric parameters that define an analytic surface region according to the vertices of the seed region, fits the analytic surface region to the seed region, determines, for each of the created seed regions, whether or not each vertex that is in the vicinity of the seed region has allowable errors relative to the position and normal of the surface fitted to the seed region, adds the vertex to the seed region if the vertex has allowable errors to thereby grow the seed region, extracts an analytic surface region representative of the grown seed region, recognizes fillet surface regions, linear-extrusion surface regions and surface regions of revolution in the extracted analytic surface regions and outputs information concerning the extracted analytic surface regions and the recognized regions.

In this way, the apparatus, method and program according to the present invention are capable of inputting a mesh model prepared from a machine part, extracting, from the mesh model, analytic surface regions (planar, cylindrical, conical, spherical and toric surface regions), and automatically recognizing fillet surface regions, linear-extrusion surface regions and surface regions of revolution from the extracted analytic surface regions.

### BRIEF DISCRIPTION OF THE DRAWINGS

FIG. 1 illustrates a block diagram showing functional blocks of an apparatus for segmentation of mesh model data into analytic surfaces according to an embodiment of the present invention.

FIG. 2 illustrates a flowchart showing steps of segmentation of a mesh model into analytic surfaces according to an embodiment of the present invention carried out in the apparatus of FIG. 1.

FIG. 3 illustrates a result of curvature estimation with sharp edges recognition.

FIGS. 4A-4D illustrate results of curvature estimation, wherein FIG. 4A illustrates an input mesh model, FIG. 4B recognized sharp vertices, FIG. 4C estimated maximum curvature and FIG. 4D estimated minimum curvature.

FIG. 5 illustrates comparison of three curvature estimation methods.

FIG. 6 illustrates a flowchart showing the details of the seed region creation process in the step 2 of FIG. 2.

FIG. 7 illustrates a curvature histogram to allocate labels for tori.

FIG. 8 illustrates a result of seed region creation.

FIG. 9 illustrates a flowchart showing the details of the analytic surface region extraction and the boundary extraction processes in the step 2 of FIG. 2.

FIG. 10 illustrates a view explaining parameters for defining a plane surface extractable in the analytic surface extracting step.

FIG. 11 illustrates a view explaining parameters for defining a spherical surface extractable in the analytic surface extracting step.

FIG. 12 illustrates a view explaining parameters for defining a cylindrical surface extractable in the analytic surface extracting step.

FIG. 13 illustrates a view explaining parameters for defining a conical surface extractable in the analytic surface extracting step.

FIG. 14 illustrates a view explaining parameters for defining a toric surface extractable in the analytic surface extracting step.

FIGS. 15A-15D illustrate a process of region growing, wherein FIG. 15A illustrates initial seed regions, FIG. 15B illustrates seed region 1 grows and two seed vertices of cone are added to the plane region and two seed vertices are left, FIG. 15C illustrates the seed region of cone with a smaller number of vertices than the threshold are deleted and FIG. 15D illustrates two analytic surfaces are extracted.

FIG. 16 illustrates a result of extracted analytic surfaces using the region growing.

FIGS. 17A-17B illustrate a result of boundary edges extraction, wherein FIG. 17A illustrates a model before boundary edges extraction process and FIG. 17B illustrates the model with extracted boundary edges.

FIG. 18 illustrates a table explaining definitions of fillet surfaces.

FIG. 19 illustrates a view explaining recognition of a torus-type fillet surface FLT1 between a conical surface and a plane surface in a recognition step 3 of FIG. 2.

FIG. 20 illustrates a view explaining recognition of a torus-type fillet surface FLT2 between a cylindrical surface and a plane surface in the recognition step 3 of FIG. 2.

FIG. 21 illustrates a view explaining recognition of a cylinder-type fillet surface FLT3 between two plane surfaces in the recognition step 3 of FIG. 2;

FIG. 22 illustrates a view explaining recognition of sphere-type and torus-type fillet surfaces among three cylinder-type fillet surfaces in the recognition step 2 of FIG. 2.

FIGS. 23A-23B illustrate a result of fillet surface recognition.

FIGS. 24 A-24C illustrate results of another fillet surface recognition, wherein FIG. 24A illustrates an input mesh model, FIG. 24B extracted analytic surfaces and FIG. 24C recognized fillet surfaces.

FIG. 25 illustrates an experimental result of recognition of a linear extrusion surface and a surface of revolution.

FIGS. 26A-26F illustrate other experimental results of respective step applied to a solid model shown in FIG. 26A, wherein FIG. 26A illustrates a picture of the solid model, FIG. 26B illustrates a scanned mesh model of the solid model, FIG. 26C illustrates seed regions extracted from the mesh model, FIG. 26D illustrates analytic surface regions extracted from the mesh model, FIG. 26E illustrates boundary edges extracted from the mesh model and FIG. 26F illustrates a linear sweep surface of the mesh model.

FIGS. 27A-27B illustrate other experimental result, wherein FIG. 27A illustrates a scanned mesh model of an automobile part and FIG. 27B illustrates extracted analytic surfaces from the mesh model.

### DISCRIPTION OF THE PREFERRED EMBODIMENT

An embodiment of the present invention will be explained in detail with reference to the drawings.

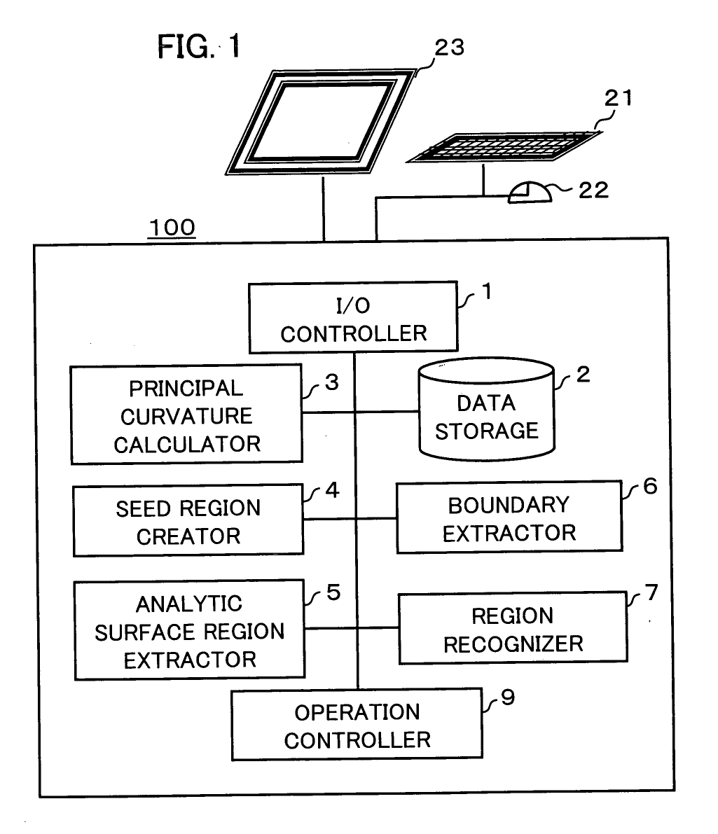

FIG. 1 is a schematic view showing an apparatus 100 of 3D mesh data into analytic surfaces according to an embodiment of the present invention. The apparatus 100 includes functional blocks that may be realized by hardware or by a combination of a computer and a program that is executed in the computer. The embodiment of FIG. 1 employs a computer and a computer executable program.

In FIG. 1, the apparatus 100 includes an I/O controller 1 as a data input and output unit. The I/O controller 1 controls inputting/outputting data signals with respect to a network and the like, signals with respect to a keyboard 21 and mouse 22, video signals with respect to a display 23, data signals with respect to peripheral devices such as a printer and the like. The apparatus 100 also includes a data storage unit 2 to store a variety of data pieces including mesh model data input through the I/O controller 1, solid model data converted from the mesh model data and program data. The data storage unit 2 may be an external or internal large-capacity storage unit such as a hard disk drive, a DVD disk drive and a CD-ROM disk drive, a permanent memory such as a flash memory and a system memory, or a temporary memory.

The apparatus 100 further includes a principal curvature calculator 3 for calculating principal curvatures on a mesh model in consideration of sharp vertices, a seed region creator 4 for creating seed regions according to the calculated principal curvatures, an analytic surface region extractor 5 for fitting an analytic surface to vertices of each of the created seed regions and expanding the analytic region according to a region growing method and a boundary edge extractor 6 for extracting boundaries of the analytic regions and establishing neighboring relationships among the analytic regions.

The apparatus 100 also includes a region recognizer 7 for recognizing fillet surface regions, linear-extrusion surface regions and surface regions of revolution according to the neighboring relationships and combinations of the analytic regions and an operation controller 9 for controlling operations of the components 1 to 7 of the apparatus 100.

A method for segmentation of scanned mesh model data into analytic surfaces according to an embodiment of the present invention carried out in the apparatus 100 will be explained hereinafter. The scanned mesh model data consists of triangle mesh model data obtained by, for example, a 3-D X-ray CT scanner. The present segmentation method extracts analytic surfaces (planar, cylindrical, conical, spherical and toric surfaces) from the mesh model data, automatically recognizes fillet surface regions, linear-extrusion surface regions and surface regions of revolution according to the analytic surfaces and provides outputs information concerning the extracted analytic surface regions and the recognized regions.

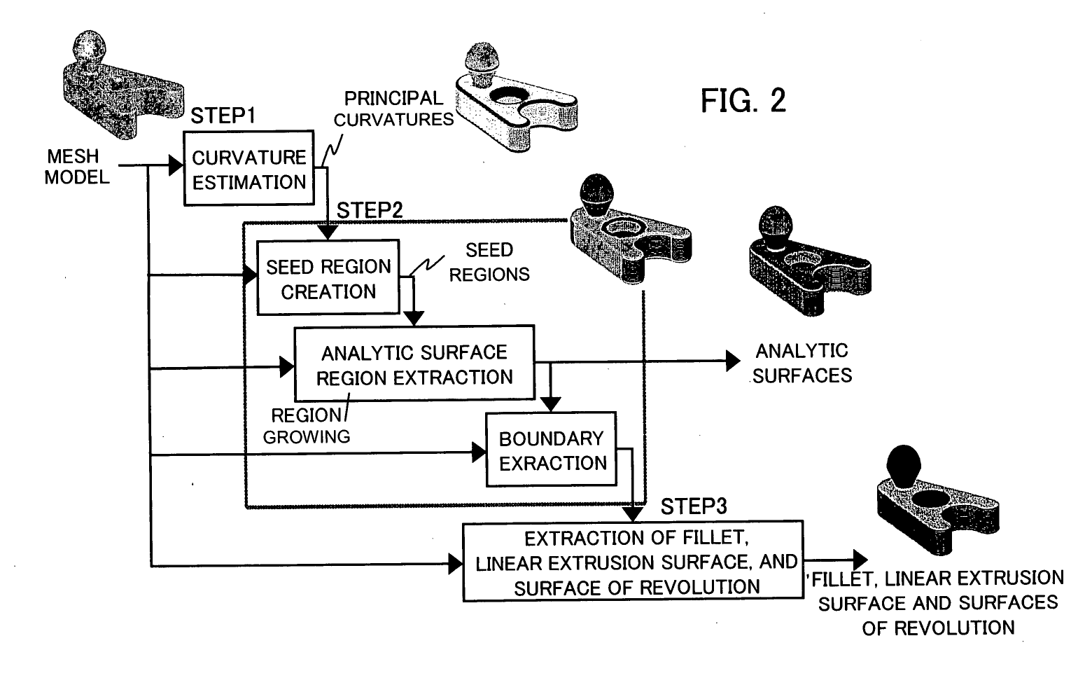

The algorithm of the present method is composed of three steps as shown in FIG. 2.

Step 1: Accurate curvature estimation based on recognition of sharp edges is carried out by the principal curvature calculator 3 (described precisely in section A)).

The present algorithm accurately estimates principal mesh curvatures based on an improved method of Razdan's [5]. The present method locally fits a biquadratic Bézier surface to a set of neighboring vertices around each vertex, and estimates two principal curvatures from the fitted surface. It allows robust estimation for a noisy scanned mesh. The algorithm has two pass curvature estimations. In the first pass, the present method finds sharp edges on the mesh based on curvature, and in the second pass, it estimates mesh curvatures that are re-calculated for the regions that do not include sharp edges. This algorithm ensures accurate mesh curvature estimation even around sharp edges where the previous methods generated large estimation error.

Step 2: Analytic surfaces extraction based on non-iterative Region Growing is carried out by the seed region creator 4 and the analytic surface region extractor 5. Furthermore, boundary edges extraction is carried out by the boundary extractor 7 (described precisely in sections B and C).

The present analytic surfaces extraction algorithm is the modified version of Vieira's region growing algorithm [3]. It first creates large seed regions for analytic surfaces extraction using mesh principal curvatures given from step 1. Next, an analytic surface is fitted to each seed region, and vertices topologically connected to seed regions with similar geometric properties are added to the seed regions. In this fit-and-add process, re-calculation of the fitting surface is not required. As a result, regions approximated by analytic surfaces can be extracted. This modified region growing enables to find accurate boundaries of underlying analytic surfaces.

Step 3: Extraction of higher-level classes of surfaces is carried out by the region recognizer 7 (described precisely in section D).

The present method classifies a greater extent of extracted analytic surfaces into higher-level classes of surfaces than those in the existing methods [4], [13] and [14]: fillet surface, linear extrusion surface and surface of revolution. This is achieved by categorizing neighboring relations of surfaces and by grouping them.

Triangular mesh models whose surfaces are completely composed of planes, cylinders, spheres, cones and tori are dealt here for simplification as an example of a mesh model (80,000 triangles) shown in FIG. 4A. This model is created by FEM meshing of a solid model. Sharp edges and corners are rounded by creating fillet surfaces with small radius on the solid model. Then artificial noise on this model is added by moving the vertex position to its normal direction using a Gaussian distributed random value. This model includes four planes, five cylinders, one sphere, one cone, one torus, two fillet surfaces, one linear sweep surface and one surface of revolution.

A) Robust Estimation of Mesh Principal Curvatures by Recognizing Sharp Edges.

A robust mesh principal curvatures estimation method recognizing sharp edges on a mesh based on an improved version of Razdan's method [5], and two-pass estimation to ensure the accuracy of curvatures are employed.

A1) Razdan's Mesh Curvature Estimation [5].

To estimate mesh curvatures on a noisy mesh model, Razdan proposed first locally fit a biquadratic Bézier surface of Eq. (1) for a mesh vertex (u,v) and a set of vertices included in its 2-ring, and to estimate mesh curvatures at the vertex from the fitted surface.

$$x ( u , v ) = {\sum }_{i = 0}^{2} {\sum }_{j = 0}^{2} {b}_{i , j} {B}_{i}^{2} ( u ) {B}_{j}^{2} ( v ) ; u , v ∈ [ 0 , 1 ] \\ {B}_{j}^{2} ( v ) = ( \begin{matrix}2 \\ j\end{matrix} ) {( 1 - v )}^{2 - j} {v}^{j} \\ {B}_{i}^{2} ( u ) = ( \begin{matrix}2 \\ i\end{matrix} ) {( 1 - u )}^{2 - i} {u}^{i} \qquad ( 1 )$$

where bᵢⱼ is a control point of the biquadratic Bézier surface, x(u,v) is a point on the surface, and Bᵢ²(u), Bⱼ²(v) are quadratic Bernstein functions.

To avoid unwanted distortion of the fitted surface due to the scanning noise in a data, a smoothing constraint is imposed that makes each of the four quadrilaterals bounded by nine control points as close to being parallelogram as possible. Razdan added this constraint to the original least square fitting problem, and controlled the smoothing effect by specifying the smoothing parameter a between 0 and 1.

A2) A Proposed Mesh Curvature Estimation and Vertex Normal Vector Calculation Method.

Razdan's method [5] as shown above is improved. The improved method fits a biquadratic Bézier for each vertex vᵢ and a set of neighboring vertices which satisfy the condition of Eq. (2), and calculates principal curvatures K_{i,max}, K_{i,min} for vⱼ from this fitted surface.
∥vⱼ−vᵢ∥<W·l_{i,avg} (2)
where l_{i,avg} is an average edge length containing the vertex vᵢ, and W is a parameter to specify the size of surface-fit.

Razdan mentioned in their paper [5] that smoothing parameter a=0.7 provides good results for noisy meshes, but in experimental results, it has been found that a=0.9 provides better results especially around sharp edges that are recognized using the proposed method. Because more number of neighboring vertices is used in the proposed method for fitting a Bézier surface than the one of Razdan's, the local least square fitting of Bézier surface itself has an smoothing effect. Therefore a=0.9 is used for all meshes in this embodiment.

The vertex normal vector of vᵢ is estimated by Eq. (3).

$${n}_{i} = \frac{{\sum }_{f ∈ {F}^{*} ( i )} {a}_{f} {n}_{f}}{‖ {\sum }_{f ∈ {F}^{*} ( i )} {a}_{f} {n}_{f} ‖} \qquad ( 3 )$$

where F*(t) is a set of triangles containing the vertex vᵢ, and a_{f} is an area of a triangle f. This normal vector is also used in the region growing step mentioned in section C2.

To robustly estimate principal curvatures on noisy scanned meshes, a parameter W should be larger. However, a larger parameter setting results in poor curvature estimation around sharp edges. To solve the problem, the following two-pass curvature estimations are preferable. In the first pass, principal curvature is estimated by fitting the surface relatively large on the surface of the mesh. For this purpose, parameters W=2 is set. If the maximum curvature K_{i,max} of the vertex vᵢ satisfies Eq. (4), the vertex is classified as a sharp vertex.

$$\frac{1}{\vert {κ}_{i , max} \vert} < {th}_{se} \cdot {l}_{i , avg} \qquad ( 4 )$$

As Vieira et al. [3] mentioned, thₛₑ=10.0 provides good results for most scanned mesh models.

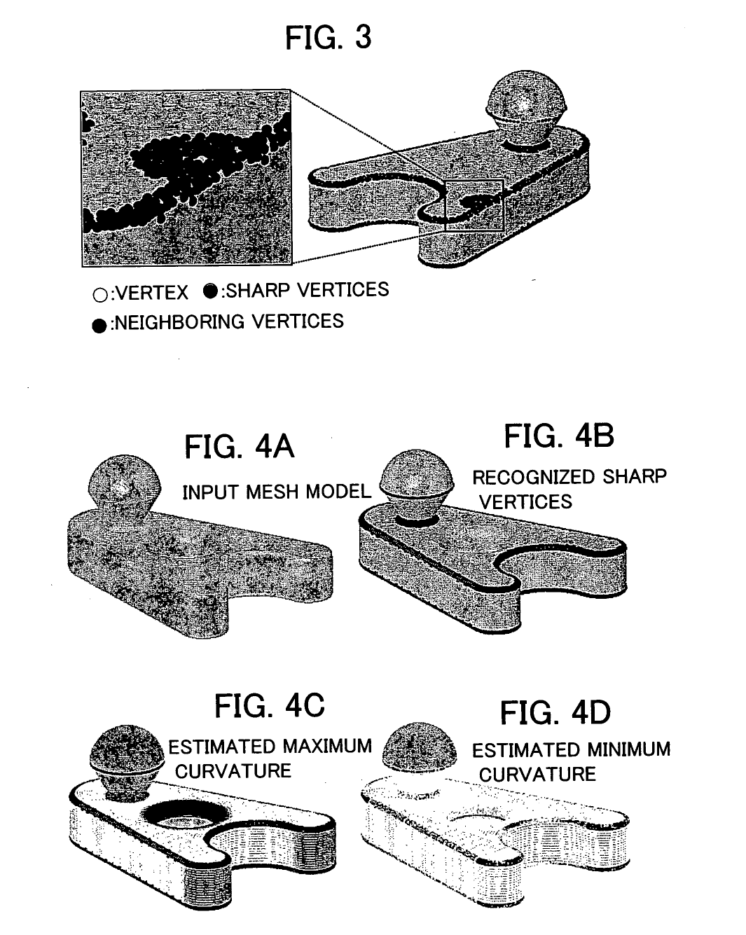

In the second pass, principal curvatures are re-calculated for non-sharp vertices with parameters W=5. In this step, sharp vertices are not included for the Bézier surface fitting as shown in FIG. 3. This results in better accuracy of principal curvatures of vertices nearby sharp edges as shown in FIGS. 4A-4D.

Moreover in the present method, the normal vector n′ᵢ for the vertex vᵢ is also re-calculated as the normal of the fitted Bézier surface. This normal vector is better in accuracy than the one calculated from Eq. (3) for noisy mesh models. The re-calculated normal vectors are used for the analytic surface fitting step described in section C1.

A3) Comparison of Curvature Estimation Methods.

Comparison of the accuracy of the maximum principal curvature estimation among three estimation methods has been carried out as in the following: one of Razdan's and two of the proposed methods consisting of the method with and without sharp edge recognition.
i) Razdan's method (a=0.7)
ii) The proposed method without sharp edges recognition (W=5, a=0.9)
iii) The proposed method with sharp edges recognition (W=2, a=0.9), (W=5, a=0.9).

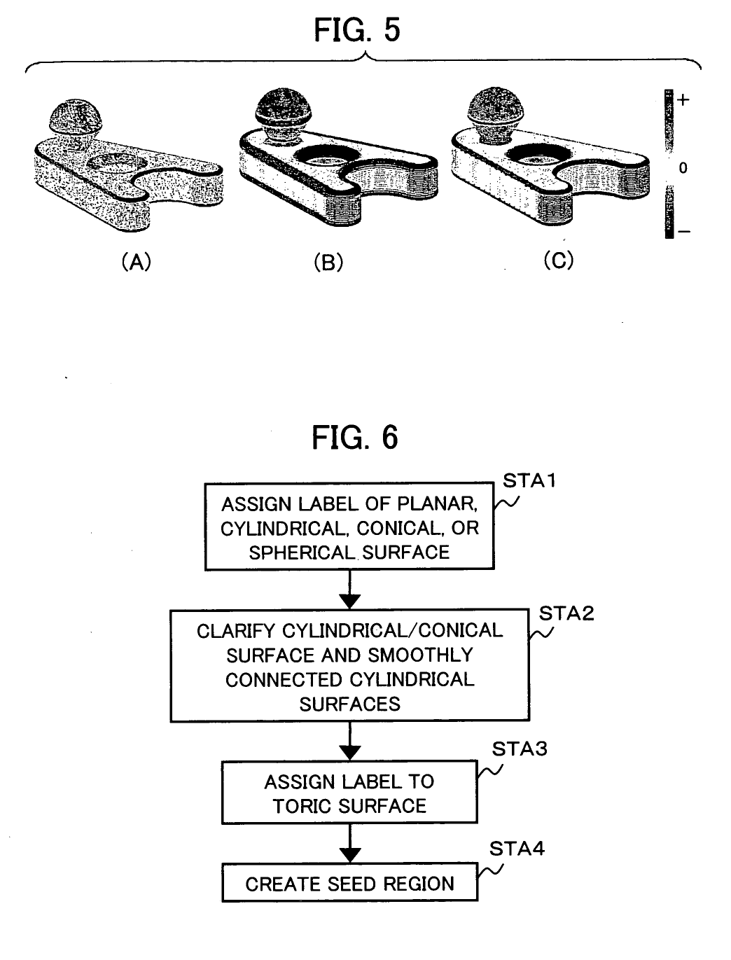

Artificial noises are added by moving the position of each vertex to its normal direction using a Gaussian distributed random value with a standard deviation of 5% of the average mesh edge length for the cylindrical mesh model shown in FIG. 5. FIG. 5 shows the comparison results. In FIG. 5(A), the curvatures vary even on the cylindrical surface where they should be theoretically constant. This shows that method (i) cannot estimate principal curvatures accurately on noisy meshes. In FIG. 5(B), curvatures look nearly constant on the cylindrical surface, but curvatures vary to a large extent near the sharp edges where cylindrical surface and plane intersect. This shows that method (ii) misestimates the evaluated principal curvature nearby the sharp edges. While in FIG. 5(C), curvatures are nearly constant on the cylindrical surface and even nearby the sharp edges. This shows that the present method can accurately estimate principal curvatures for noisy meshes including sharp edges.

A4) Curvature Filtering.

The proposed method can accurately estimate mesh principal curvatures. However estimation errors are unavoidable due to scanning noises. Therefore the estimated curvatures are smoothed by the filtering method proposed by Vieira [3].

First, median filtering in Eq. (5) is applied to the non-sharp vertices for eliminating the vertices with outlier irregular principal curvatures. It is applied to the 1-ring neighborhood N*(i) of a vertex Vᵢ not including sharp vertices as follows:
(κ_{i,max})_{new}=median[κ_{j,max}]_{j∈N*(i)} and (κ_{i,min})_{new}=median[κ_{j,min}]_{j∈N*(i)} (5)

Next, mean filtering in Eq. (6) is applied three times to the non-sharp vertices to smooth principal curvatures. This is also applied to the 1-ring neighborhood N*(i) not including sharp vertices.

$${( {κ}_{i , max} )}_{new} = \frac{1}{n} {\sum }_{j ∈ {N}^{*} ( i )} {κ}_{j , max} and {( {κ}_{i , min} )}_{new} = \frac{1}{n} {\sum }_{j ∈ {N}^{*} ( i )} {κ}_{j , min} \qquad ( 6 )$$

B) Seed Region Creation.

Next, seed regions are created on the surface of a mesh by classifying estimated principal curvatures. In this method, a seed region means a set of topologically connected vertices that are supposed to be on a certain analytic surface.

B1) Allocating Initial Labels to Vertices.

The process of seed region creation is divided into three steps as shown in FIG. 6.

Step STA1: Allocation of Initial Labels for Planes, Cylinders/Cones and Spheres to the Vertex.

An initial label for plane, cylinder/cone and sphere that discriminates on which surface a vertex lies are allocated to each vertex vᵢ. The present method allocates the labels for non-sharp vertices classified in section A2 according to Eq. (7) by evaluating two principal curvatures. Three parameters e₁, e₂ and e₃ are used in Eq. (7). For most mesh models, e₁=0.01, e₂=0.01 and e₃=0.01 provide good results, but they must be set properly depending on mesh geometries and mesh resolutions in case of complex geometry.

$$label ( {v}_{i} ) = \{ \begin{matrix}1 & ( plane ) & if ( \vert {κ}_{i , max} \vert < {ɛ}_{1} ) \\ 2 & ( cylinder , cone ) & else if ( \vert {κ}_{i , min} \vert < {ɛ}_{2} ) \\ 3 & ( sphere ) & else if ( \begin{matrix}\vert {κ}_{i , max} - {κ}_{i , min} \vert < {ɛ}_{3} \\ and {k}_{i , max} \cdot {k}_{i , min} > 0\end{matrix} ) \\ 0 & ( others ) & otherwise\end{matrix} \qquad ( 7 )$$

Step STA2: Classification of Cylinders/Cones and Smoothly Connected Cylinders.

At the step STA1 the label 2 was allocated for both cylinders and cones. In this step, these cylinders and cones are discriminated. The smoothly connected cylinders are also separated into different single cylinders. To achieve this discrimination, a similarity value of the principal maximum curvature f(vᵢ) is calculated for each vertex vᵢ according to Eq. (8).

$$f ( {v}_{i} ) = \frac{1}{n} {\sum }_{j ∈ {N}^{**} ( i )} \vert ( {κ}_{i , max} - {κ}_{j , max} ) / {κ}_{i , max} \vert \qquad ( 8 )$$

where N**(i) is a set of vertices in 2-ring of the vertex Vᵢ. If f(vᵢ) is larger than the threshold th_{cyl}_{_{—}}_{cone}, the vertex is assumed to belong to a cone and label (vᵢ) is changed to 4. If f(vᵢ) is smaller than the threshold, label (vᵢ) is preserved. For an implementation, th_{cyl}_{_{—}}_{cone}=0.01-0.4 provides a good result. In this step, vertices in very small and thin areas which lie near boundaries of two smoothly connected cylinders are sometimes recognized as cone, but these small boundary areas disappear in the later analytic surface extraction step.

Step STA3: Allocation of Initial Labels for Tori.

Previous two steps allocate labels for plane, cylinder, sphere and cone, therefore most of vertices with label 0 are assumed to lie on tori. To allocate torus labels to such vertices, principal curvatures of vertices that have label 0 are evaluated.

A torus is the excursion surface where a sphere is rotated along an axis. Therefore one of the principal curvatures corresponds to the constant curvature of the radius r of the sphere. This property is used to create a histogram of discretized principal curvatures for a set of vertices that have the label 0 as shown in FIG. 7. If the number of vertices that has a particular discretized curvature value is larger than the threshold thₜₒᵣᵤₛ, label 5 is allocated to their vertices. In an implementation, 0.01 for the step of principle curvature and 0.1-0.5% of the number of all vertices for thₜₒᵣᵤₛ provided good results for most mesh models.

Step STA4: Creation of Seed Regions.

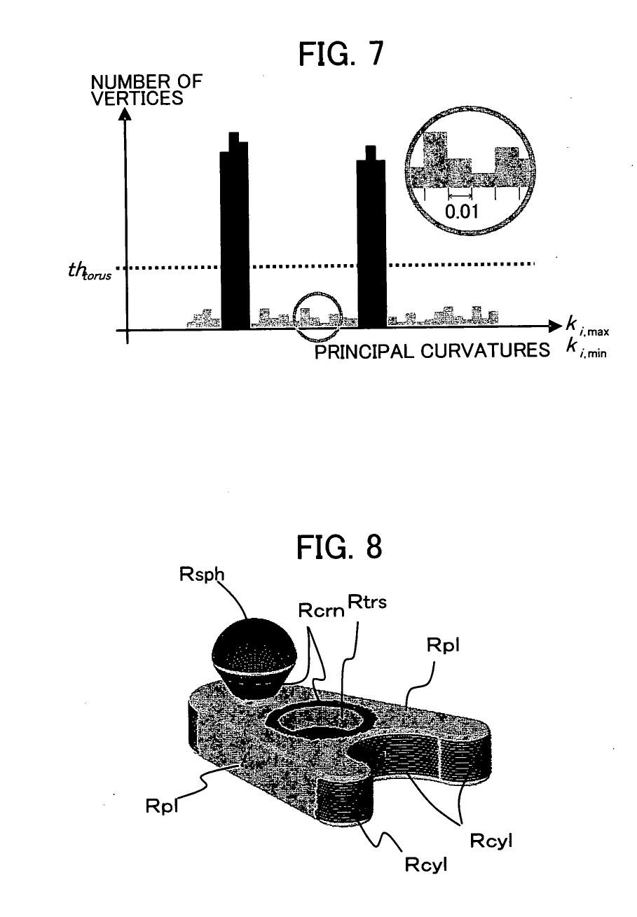

Finally, a seed region is created as a set of topologically connected vertices with the same label that has the number of vertices larger than the threshold th_{seed} shown in table 1. In an implementation, th_{seed} corresponds to the minimum number of vertices which enables the least square analytic surface fitting that is proposed by this method, and is described in section C1. FIG. 8 shows the results of seed region creation, wherein Rshp indicates a sphere, Rcyl a cylinder, Rcrn a cone, Rpl a plane and Rtrs a torus, respectively.

TABLE 1
Threshold for seed region creation

| | surface type | | | | |
|---|---|---|---|---|---|
| | plane | cylinder | sphere | cone | torus |
| threshold th_{seed} | 2 | 4 | 5 | 4 | 9 |

C) Analytic Surface Extraction.

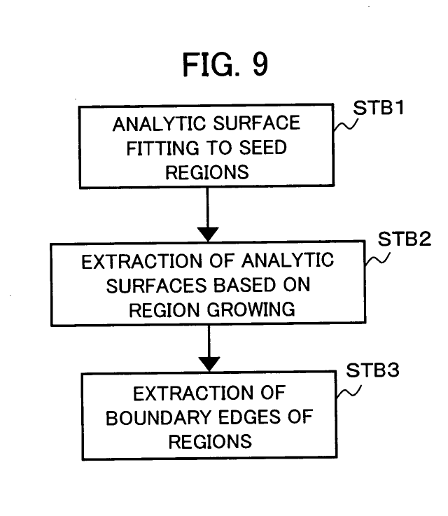

The analytic surface extraction process consists of three steps as shown in FIG. 9: such as step STB1 analytic surface fitting to seed regions, step STB2 region growing and step STB3 boundary edge extraction of grown regions.

Step STB1: Analytic Surfaces Fitting to Seed Regions.

After creating seed regions for different kinds of analytic surfaces based on the analysis of principal curvatures of a mesh surface, an appropriate surface is fitted to the seed region and its geometric parameters that define the surface are calculated.

Much research has been done to fit analytic surfaces to scanned data in the field of reverse engineering [16], [17] and [18]. Marshall et al. [18] proposed a non-linear method to accurately fit analytic surfaces including spheres, cylinders, cones and tori [18]. In this method, the accuracy of fitting was better than the linear methods. However it needed large calculation time to solve non linear problems iteratively.

In this embodiment, an efficient analytic surface fitting by utilizing pre-computed normal vectors n′ᵢ by solving linear least squares problems to find fitted planes, cylinders, spheres and cones is employed. This method is less accurate than Marshall's method, but faster than it, and provides a practically enough results for analytic surface extraction.

[Plane Fitting]

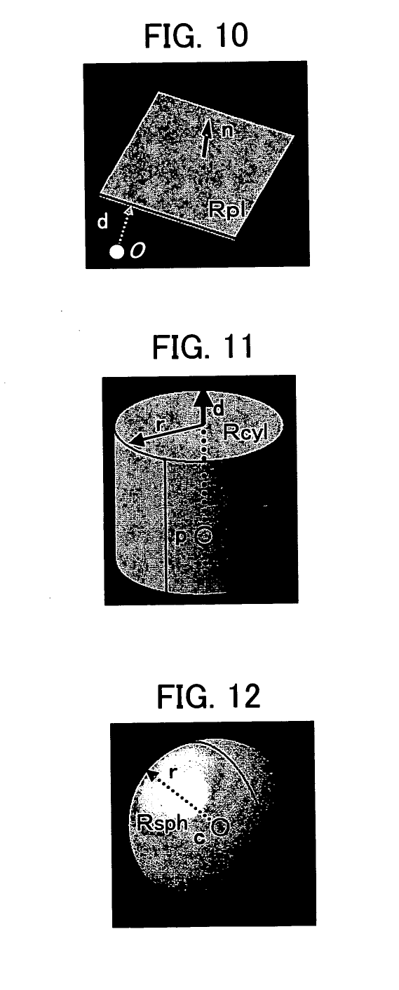

As illustrated in FIG. 10, a plane is defined by its unit normal vector n=(nₓ,n_{y},n_{z}) and a distance d from an origin O. The present method calculates n as the normalized average vector of vertex normals n′ᵢ in a seed region of the plane. The distance d is calculated using Eq. (9).

$$d = - \frac{1}{n} ( {\sum }_{i = 1}^{n} ( {n}_{ix}^{′} {v}_{ix} + {n}_{iy}^{′} {v}_{iy} + {n}_{iz}^{′} {v}_{iz} ) ) \qquad ( 9 )$$

[Cylinder Fitting]

As illustrated in FIG. 11, a cylinder is defined by its unit axis direction vector d=(dₓ,d_{y},d_{z}), radius r, and an arbitrary point on the axis p=(pₓ,p_{y},p_{z}). First, all of vertex normals n′ᵢ in a seed region are mapped onto a Gaussian sphere. Then a least square plane is fitted so that the plane passes through the end points of n′ᵢ in this Gaussian sphere. The axis direction is derived as a unit normal vector of this least square plane. Next, all vertices in a seed region are projected onto the plane whose normal vector is d. Then, a circle is fitted to these projected points on the plane in the least squares sense, and the radius r is calculated as the radius of the fitted circle. Finally, the center coordinate of the circle is also calculated on the projected plane, and it can be easily transformed to p.

[Sphere Fitting]

As illustrated in FIG. 12, a sphere is defined by its center c=(cₓ,c_{y},c_{z}) and radius r. The present method solves a linear least squares problem to find the coefficients (A,B,C,D) defining the sphere equation of Eq. (10). They are easily converted into the center c and radius r.
x²+y²+z²+Ax+By+Cz+D=0 (10)

[Cone Fitting]

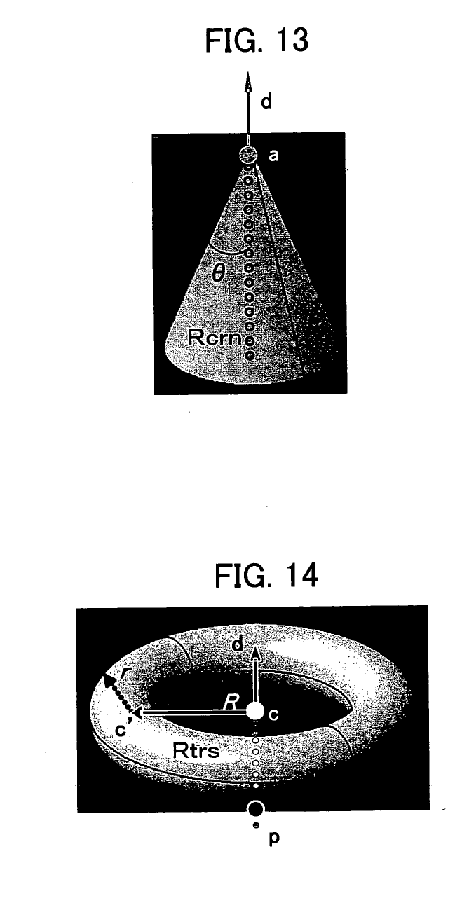

As illustrated in FIG. 13, a cone is defined by its unit axis direction vector d=(dₓ,d_{y},d_{z}), apex a=(aₓ,a_{y},a_{z}) and vertical angle θ. The unit axis direction vector d is calculated using the same method as for a cylinder. An apex a is given from the condition that a vector passing through a and vᵢ is orthogonal to a normal vector of the vertex n′ᵢ. This is obtained by finding a least squares solution of a in Eq. (11).
n′ᵢₓ(aₓ−vᵢₓ)+n′_{iy}(a_{y}−v_{iy})+n′_{iz}(a_{z}−v_{iz})=0 (11)

A vertical angle θ is calculated as the average of angles between d and a vertex normal n′ᵢ in Eq. (12).

$$θ = \frac{1}{n} {\sum }_{i = 1}^{n} {sin}^{- 1} ( {d}_{ix} {n}_{ix}^{′} + {d}_{iy} {n}_{iy}^{′} + {d}_{iz} {n}_{iz}^{′} ) \qquad ( 12 )$$

[Torus Fitting]

As shown in FIG. 14, a torus is defined by its unit axis direction vector d=(dₓ,d_{y},d_{z}), its center c=(cₓ,c_{y},c_{z}), the radius of its body r and the radius of the centerline of the torus body R. To calculate these parameters, the same method as Kós et al. [16] is used for a calculation of torus axis. K\acute{0}s first calculated the initial estimates of axis direction and an arbitrary point on the axis using eigen analysis, and then the precise solutions of them are calculated by the iterative method from these initial estimates. First, it is used the Kós's initial estimates as final solutions of axis direction d and an arbitrary point p on the axis for fitting torus. Then c, r and R are calculated using the axis direction d and an arbitrary point p on the axis.

In above mentioned fittings, calculation of axis direction and an arbitrary point on the axis is carried out by utilizing Kós's method [16].

Let p an arbitrary point on the axis and p₀=P*d. And the angle between d and n′ᵢ is denoted by fᵢ, and the distance between the normal line vᵢ+tn′ᵢ and the axis by dᵢ.

In Kós's method,
Σ(δᵢ sin φᵢ)²
was minimized to calculate d and p, where
δᵢ sin φᵢ=|(d×n′ᵢ)·(p−vᵢ)|=|n′ᵢ·p₀+(vᵢ×n′ᵢ)·d| (13)
is a linear function of p₀ and d.
Σ(δᵢ sin φᵢ)²
can be written as a simple quadratic form on p₀ and d under the constraints |d|=1 and p₀*d=0. Discarding the constraint p₀*d=0 changes the problem to a simple eigenvalue problem, d and p are calculated as a result.

In above mentioned torus fitting, calculation of the center C, the radius r of the torus body, and the radius R of the centerline of the torus body is carried out as below.

All vertices in a seed region are rotated around the calculated axis so as to be placed onto a plane which include the calculated axis, then a circle is fitted to the points on the plane in the least squares sense. The radius r is calculated as the one of that circle. The center C is calculated according to the condition that the vector toward the center of the torus C from the center of the circle is orthogonal to the torus axis. The radius R is also calculated as the length between the center of the torus and the center of the circle.

Step STB2: Extraction of Analytic Surfaces Based on Region Growing.

From the process described in the previous processes, the analytical surface fitted to the seed region has been estimated. The proposed region growing method makes a set of vertices adjacent to the seed region added to the original seed region if the vertex lies on the fitted surface within a specified tolerance. Therefore a positional error e_{i,pos} and a directional error of the normal e_{i,norm} of the vertex vᵢ are calculated, and the vertex which is adjacent to the seed region and satisfies Eq. (14) and Eq. (15) are added to the seed regions.
e_{i,pos}<thₚₒₛ·l_{avg} (14)
e_{i,norm}<thₙₒᵣₘ (15)
where l_{avg} is an average length of all mesh edges. Thresholds thₚₒₛ=0.5 and thₙₒᵣₘ=8.0 provide good results for scanned data.

This region growing is done for the seed region in the descending order of the number of vertices in the region. This enables to generate a small number of larger regions. If all the vertices adjacent to the region do not satisfy Eq. (14) or Eq. (15), the region growing stops. The region can be extracted as a set of topologically connected vertices that are approximated by a particular analytic surface.

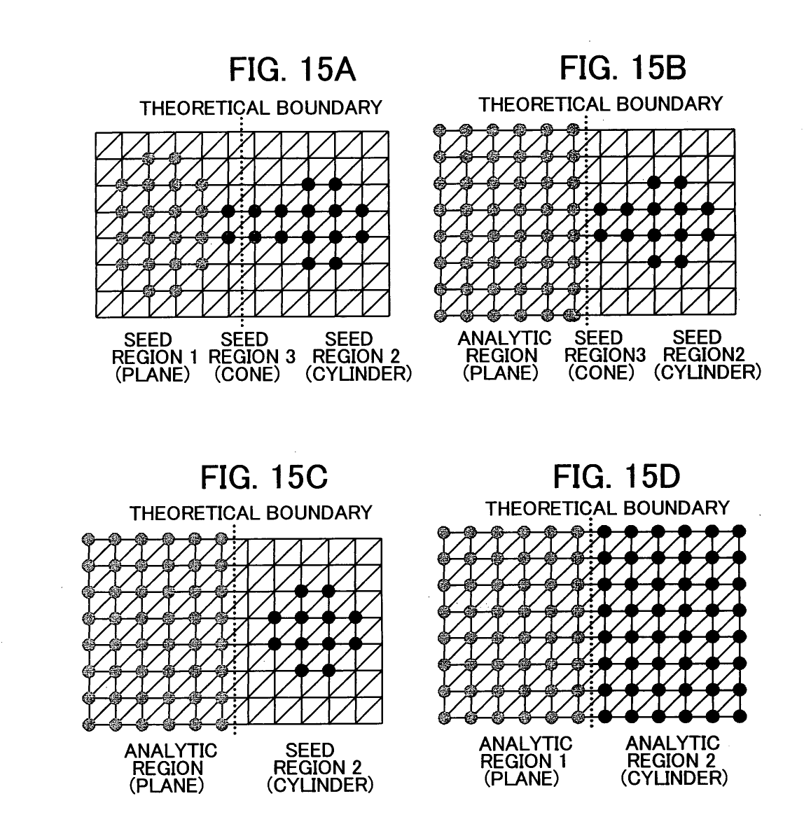

FIGS. 15A-15D illustrate a process of region growing, wherein FIG. 15A illustrates initial seed regions, FIG. 15B illustrates seed region 1 grows and two seed vertices of cone are added to the plane region, and two seed vertices are left, FIG. 15C illustrates the seed region of cone with a smaller number of vertices than the threshold are deleted and FIG. 15D illustrates two analytic surfaces are extracted.

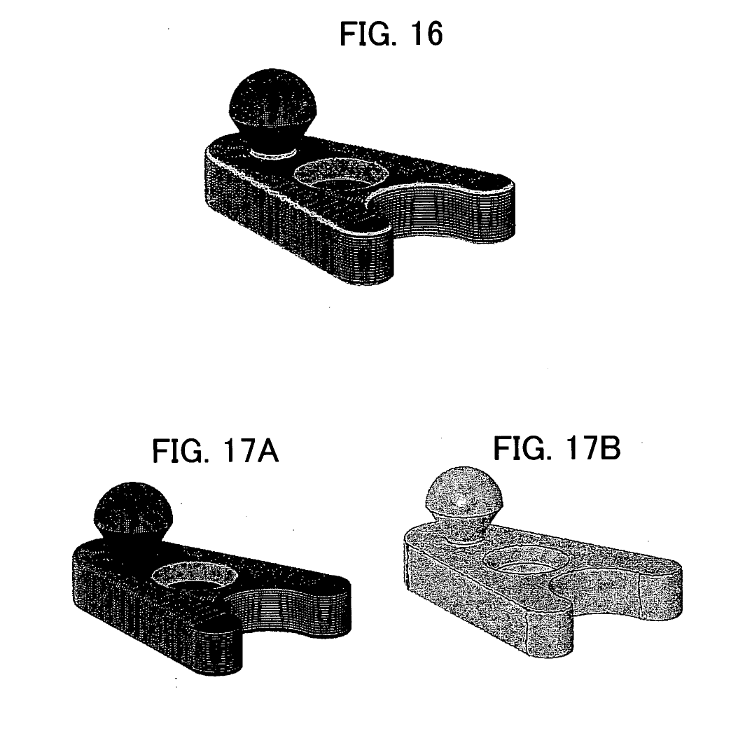

As shown in FIGS. 15A-15D, the region growing starting from one seed region may make a vertex that originally belongs to the other seed region, added to it. In this case, the joined vertex is deleted from its original seed region. If the number of vertices remaining in a seed region is larger than a threshold th_{seed}, it is preserved as a seed region, or otherwise it is eliminated from the seed region. FIG. 16 shows a result of the extracted analytic surfaces derived from the proposed region growing.

Step STB3: Extraction of Boundary Edges of the Regions.

The segmentation method next extracts boundary edges of a region to construct neighboring relations among the regions. In the previous steps, some vertices around sharp edges are sometimes left which are not added to any regions. To add such vertices to one of the existing regions, region growing continues with gradually larger thresholds (thₚₒₛ, thₙₒᵣₘ) which vary at each step (for example, (1.0, 16.0), (1.5, 24.0), (2.0, 32.0) . . . ) until all vertices are completely added to any region. As a result, a region label is completely allocated to all vertices.

To extract boundary edges of the regions, region labels are also allocated to each triangle based on the region labels already allocated to vertices. If three vertices of a triangle have the same region label, the same label is allocated to the triangle. If three vertices have different region labels, the triangle normal vector is compared with the normals of the regions specified by the labels of the three vertices. The label of the region that produces the minimal error of normal vectors is allocated to the triangle. Finally, a mesh edge with two connecting triangles having different region labels is extracted as a boundary edge. FIGS. 17A-17B show the results of boundary edges extraction of regions.

D) Recognition of Fillet Surfaces, Linear Extrusion Surfaces and Surfaces of Revolution.

For the effective use of a mesh model in various mesh applications, the present method recognizes fillet surfaces, linear extrusion surfaces and surfaces of revolutions which are often included in most engineering parts from a mesh model. The present method derives such regions based on neighboring relations or combinations of extracted analytic surface regions.

D1) Recognition of Fillet Surfaces.

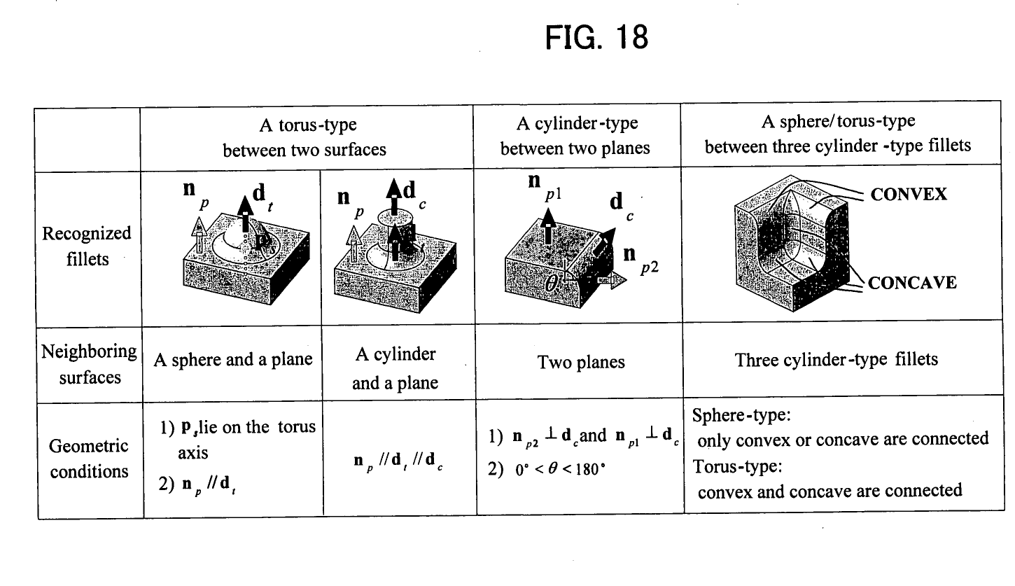

Fillet surface is a surface created by rounding sharp edges and corners of a solid model according to the specified radii. It is assumed that all surfaces in a mesh model are covered with analytical surfaces, and fillet surfaces are also represented by them. This assumption enables to classify fillet surfaces into three types: cylinders, spheres and tori [19]. These surfaces can be defined based on their geometric parameters and combinations of neighboring surfaces as shown in FIG. 18 and FIG. 19 to FIG. 22.

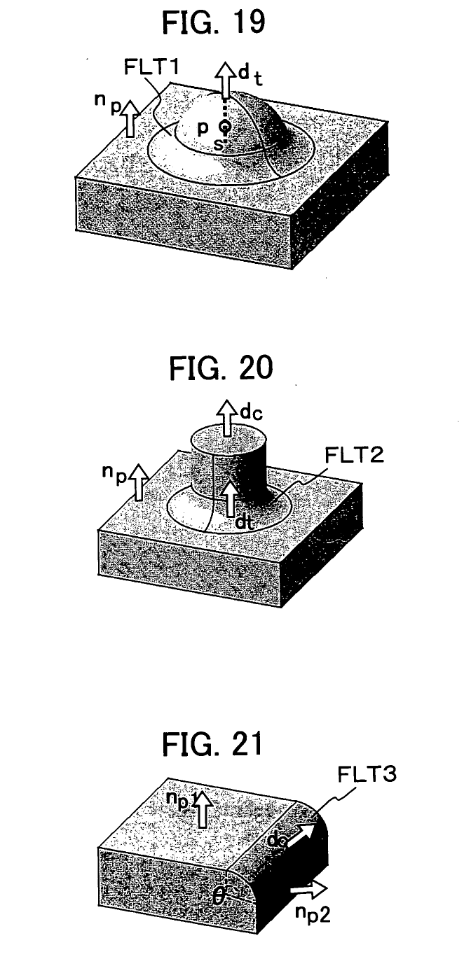

Among the extracted toric, spherical and cylindrical surface regions, regions that are between neighbor surfaces and satisfy geometric conditions are recognized as a torus-type fillet surface region FLT1 (FIG. 19) between two surfaces, a torus-type fillet surface region FLT2 (FIG. 19) between two surfaces, a cylinder-type fillet surface FLT3 (FIG. 21) between two surfaces, and sphere-/torus-type fillet surfaces FLT4 and FLT4′ (FIG. 22) each between three surfaces.

The fillet surface FLT1 of FIG. 19 is of a torus-type I and is defined by a neighboring surface condition that it is adjacent to a spherical surface and a plane surface and geometric conditions that (1) a normal vector nₚ of the plane surface is in parallel with an axial vector dₜ of a torus and (2) a center pₛ of the spherical surface is on the axis of the torus.

The fillet surface FLT2 of FIG. 19 is of a torus-type II and is defined by a neighboring surface condition that it is adjacent to a cylindrical surface and a plane surface and a geometric condition that a normal vector nₚ of the plane surface, an axial vector dₜ of a torus and an axial vector d_{c} of the cylindrical surface are in parallel with one other as follows:
nₚ//dₜ//d_{c}

The cylinder-type fillet surface FLT3 of FIG. 21 is between two surfaces and is defined by a neighboring condition that it is adjacent to the two plane surfaces and geometric conditions that (1) an axial vector d_{c} of the cylindrical surface is orthogonal to normal vectors nₚ₁ and nₚ₂ of the plane surfaces and (2) an opening angle θ of the cylindrical surface satisfies 0°<θ<180°. Namely, the geometric conditions are as follows:

(1) nₚ₂⊥d_{c} and nₚ₁//d_{c}, and

(2) 0°<θ<180°

The sphere-/torus-type fillet surfaces FLT4 (convex) and FLT4′ (concave) of FIG. 22 each between three surfaces are defined by a neighboring condition that three cylinder-type fillet surfaces are adjacent to each other and geometric conditions that (1) the three cylindrical surfaces are all convex or concave surfaces if it is a sphere-type fillet surface and (2) the three cylindrical surfaces are a mixture of convex and concave surfaces if it is a torus-type fillet surface.

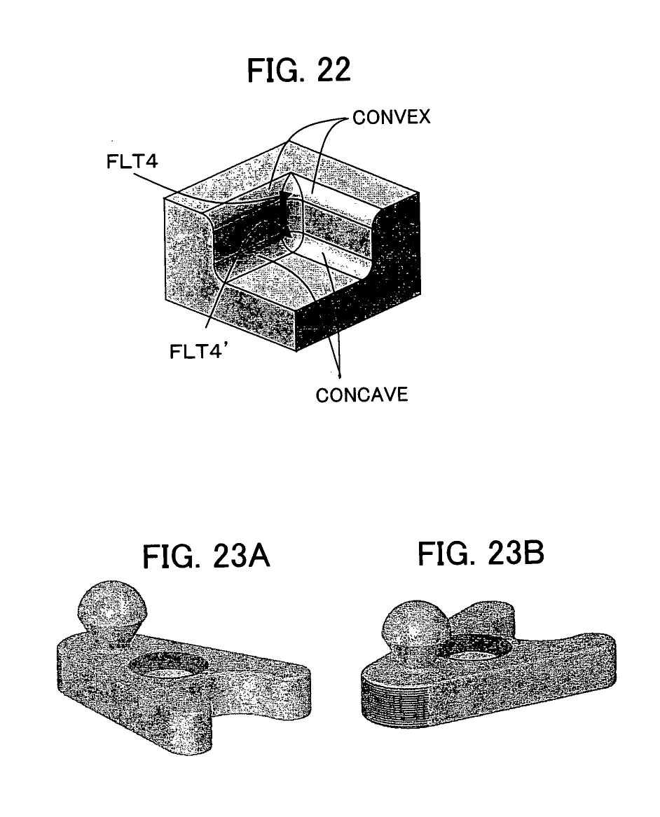

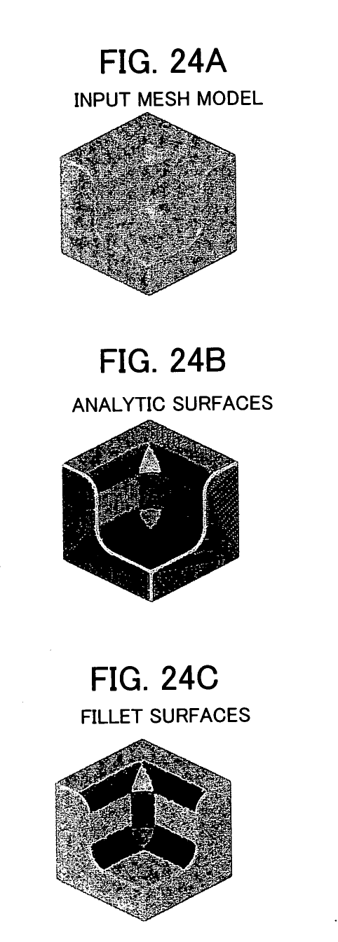

There are many other kinds of combinations other than the definition, but the present method only deals with the three types since they often appear in engineering parts more than anywhere else. Of course, other types of fillet surfaces with different combinations are also easily defined in the same way. FIGS. 23A-23B and FIGS. 24A-24C show the results of the fillet surface recognition.

D2) Recognition of Linear Extrusion Surfaces.

A linear extrusion surface is created by extruding a 2D curve defined on a plane along its normal direction. In an assumption, the surface is composed of a combination of some planes and cylinders.

These constituents must satisfy the following three conditions:

1) A plane normal and a cylinder axis must be orthogonal,

2) Normal vectors of three or more planes must be coplanar, and

3) Axes of two or more cylinders must be parallel.

The present method recognizes a set of topologically connected analytic surfaces satisfying the above three conditions as a linear extrusion surface. FIGS. 23A-23B shows results of recognizing a linear extrusion surface.

D3) Recognition of Surfaces of Revolution.

A surface of revolution is a one created by rotating a 2D curve around a rotation axis. In an assumption, the surface is composed a combination of planes, cylinders, spheres, cone and tori.

These constituents must satisfy the following two conditions:

1) Normal vectors of planes and axis directions must be parallel, and

2) Center points of spheres and tori, apexes of cones and arbitrary points of axes of cylinders must lie in a same line with a direction parallel to their normals or axis directions.

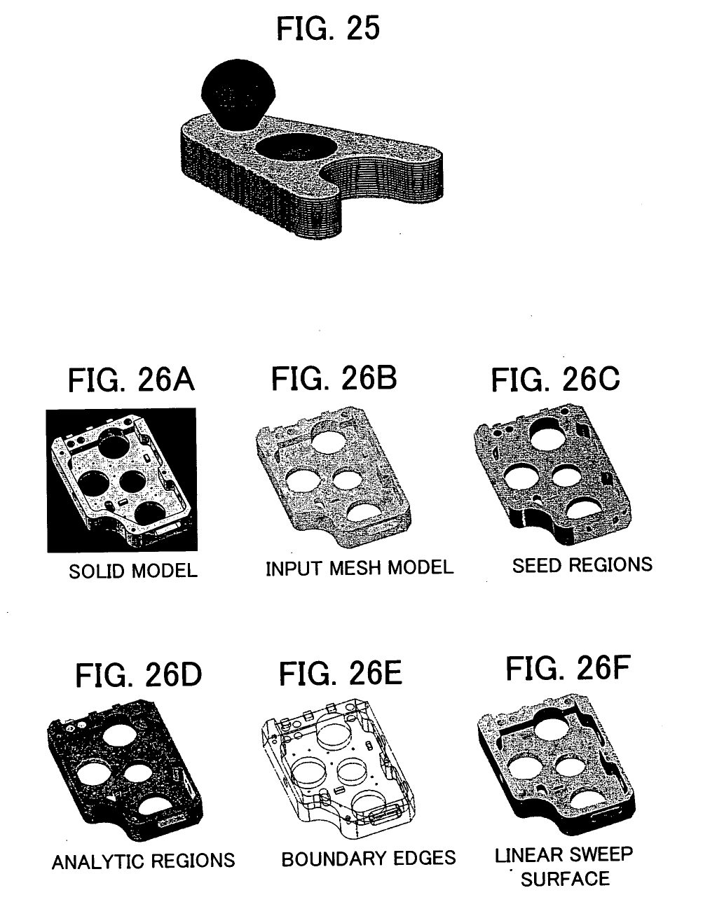

FIG. 25 also includes a result of recognition of the surface of revolution.

### EXAMPLES

FIGS. 4A-4D, FIGS. 7-8, FIG. 16, FIGS. 17A-17B and FIG. 25 show experimental results to a mesh model for verification. They show that method could work well for a noisy mesh model, and could extract proper regions. Table 2 shows a result of the fitting errors by comparing the positions or the normal/axis directions with the theoretical values derived from a solid model. The average edge length of the mesh model is about 1.8 mm.

FIGS. 26A-26F show the results to a mesh model (300,000 tri) for verification which was created by the same method as the mesh model in FIG. 4A. It shows that the present segmentation method can extract regions from a noisy complex shaped model, and that the present method can find accurate boundaries of underlying analytic surfaces. This model is composed of only planes and cylinders. The present method extracted 49 plane regions out of 51 and 28 cylinders regions out of 40. The present method properly extracted relatively large regions, but it could not extract two thin plane regions, twelve hole-type cylinder regions with small radius regions. Fitting error was relatively small even for regions with a small number of vertices; for example, axis/normal direction error was about one degree for regions with about a hundred vertices. The maximum fitting errors were about 8.8 degrees for the normal direction of plane seed regions with 27 vertices, and 3.0 degrees for the axis direction of cylinder seed region with 85 seed vertices. The running time was 92 seconds for two-pass curvature estimation and 15 seconds for analytic surfaces extraction.

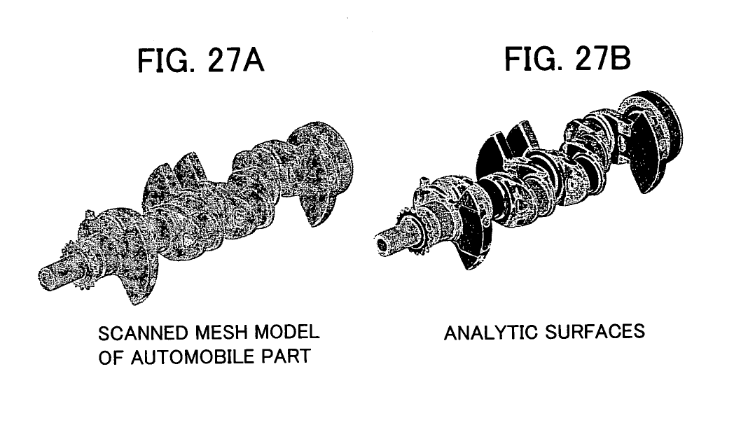

FIGS. 27A and 27B show the results for the mesh model created by CT-scanning of an automotive engine part. It shows that the present method could well extract planes and cylinders with relatively large areas from the model. Especially it could extract all functionally important cylindrical regions (fitted with bearings). The model has about 1,000,000 triangles and the present method could extract regions in less than 7 minutes.

TABLE 2
Results to the analytic surface fitting accuracy
(a) Results of plane fitting

| | plane 1 | plane 2 | plane 3 | plane 4 |
|---|---|---|---|---|
| number of seed vertices | 6769 | 5407 | 2005 | 1998 |
| normal direction error | 0.0043 | 0.0514 | 0.0859 | 0.0916 |
| (degree) | | | | |
| positional error (mm) | 0.0002 | 0.0398 | 0.0350 | 0.0244 |

(b) Results of cylinder fitting

| | cylinder 1 | cylinder 2 | cylinder 3 | cylinder 4 | cylinder 5 |
|---|---|---|---|---|---|
| number of | 2332 | 1280 | 1039 | 752 | 728 |
| seed vertices | | | | | |
| axis | 0.0088 | 0.0704 | 0.3776 | 0.1761 | 0.1096 |
| direction | | | | | |
| error | | | | | |
| (degree) | | | | | |
| positinal | 0.2837 | 0.0253 | 0.7798 | 0.1519 | 0.0798 |
| error | | | | | |
| (mm) | | | | | |
| radius error | 0.0058 | 0.0029 | 0.0196 | 0.0107 | 0.0034 |
| (mm) | | | | | |

(c) Results of sphere/cone/torus fitting

| | sphere | cone | torus |
|---|---|---|---|
| number of seed vertices | 3127 | 1787 | 1273 |
| axis direction error (degree) | — | 0.1002 | 0.0339 |
| radius error (mm) | 0.0058 | — | 0.1613 |
| Large radius error (mm) | — | — | 0.1486 |
| verticle angle error (degree) | — | 0.2678 | — |
| center/apex error (mm) | 0.0036 | 0.3933 | 0.2937 |

This segmentation method can systematically extract analytic surface regions from a mesh model. This method is based on the accurate mesh curvature estimation with sharp edge recognition and the non-iterative region growing to extract regions of which each can be approximated by plane, cylinder, sphere, cone and tori. This segmentation method can also recognize higher-level classes of surfaces: fillet surface, linear extrusion surface and surface of revolution based on the classification of neighboring relations or combinations of extracted analytic surfaces.

From the simulation and the experiment for the various mesh models, it has been found that the present method could produce an accurate and practical geometric model consisting of a set of analytic surfaces, fillet surfaces, linear extrusion surfaces and surfaces of revolution from mesh models.

Typical applications of the present segmentation method are the mesh generation, the mesh deformation for FEM meshes in the CAE pre-processor, and automatic solid models generation for reverse engineering.

What is claimed is:

1. An apparatus for segmentation of mesh model data into analytic surfaces, comprising:
an input unit configured to input mesh model data;
a principal curvature calculator configured to find, in the mesh model data, sharp vertices each having a principal curvature (maximum principal curvature) greater than a threshold, exclude the sharp vertices, and calculate principal curvatures at each non-sharp vertex in the mesh model data;
a seed region creator configured to create, from the calculated principal curvatures, seed regions each being considered to belong to an analytic surface region and including a set of linked vertices;
a surface fitting unit configured to determine, for each of the created seed regions, geometric parameters that define an analytic surface region according to the vertices of the seed region and fit the analytic surface region to the seed region;
an analytic surface region extractor configured to determine, for each of the created seed regions, whether or not each vertex that is in the vicinity of the seed region has allowable errors relative to the position and normal of the surface fitted to the seed region, add the vertex to the seed region if the vertex has allowable errors to thereby grow the seed region, and extract an analytic surface region representative of the grown seed region;
a surface region recognizer configured to recognize fillet surface regions, linear-extrusion surface regions and surface regions of revolution in the extracted analytic surface regions; and
an data output unit configured to output information concerning the extracted analytic surface regions and the recognized regions.

2. The apparatus of claim 1, wherein:
the principal curvature calculator sets a parameter for determining a curvature evaluating range of each vertex twice as large as an average length of edges connected to the vertex, calculates principal curvatures at the vertex, classifies the vertex as a sharp vertex if a maximum principal curvature thereof is greater than the threshold, sets a parameter for determining a curvature evaluating range of each non-sharp vertex five times as large as an average length of edges connected to the non-sharp vertex, and calculates principal curvatures at the non-sharp vertex.

3. The apparatus of claim 1, wherein the seed region creator comprises:
a vertex labeling unit configured to examine the principal curvatures of each vertex calculated by the principal curvature calculator and assign to the vertex a label indicative of one selected from the group consisting of a plane surface, a cylindrical surface, a conical surface, a spherical surface and an optional surface to which the vertex belongs; and
a seed region extractor configured to extract, as a seed region, a set of linked vertices having the same label assigned by the vertex labeling unit.

4. The apparatus of claim 3, wherein:
the vertex labeling unit prepares, for vertices to which the optional surface label is assigned, a histogram with an abscissa representing principal curvatures and an ordinate representing the numbers of vertices and assigns a toric surface label to a group of vertices which have a predetermined principal curvature and whose number is greater than a threshold on the histogram.

5. The apparatus of any one of claims 3 and 4, wherein, when fitting any one of a cylindrical surface and a conical surface to a seed region, the surface fitting unit:
fits a plane to intersections between normals at vertices contained in the seed region and a Gaussian sphere and determines a normal of the plane as a direction of an axis;
for the cylindrical surface, projects the vertices contained in the seed region to a plane that has a normal in the axis direction and crosses an origin, fits a circular arc to the projected vertices, and finds a center of the circular arc and an arbitrary point on the axis; and
for the conical surface which satisfies a condition that a vector connecting the apex of the conical surface to each mesh vertex is orthogonal to a normal at the mesh vertex, calculates the apex of the conical surface according to the least square method and finds an apex angle according to an average of angles between the axis direction and the normals at the mesh vertices.

6. The apparatus of any one of claims 3 and 4, wherein, when fitting a toric surface to a seed region, the surface fitting unit:
finds a direction of an axis and an arbitrary point on the axis, and according to the axis direction and arbitrary point, uses the least square method to calculate a center, major radius and minor radius of the toric surface on condition that a minor-radius center is found by inwardly extending normals at mesh vertices for the minor radius and the major radius is found as a distance between the center and the minor-radius center.

7. A method for segmentation of mesh model data into analytic surfaces, comprising:
inputting mesh model data;
finding, in the mesh model data, sharp vertices each having a principal curvature (maximum principal curvature) greater than a threshold, excluding the sharp vertices, and calculating principal curvatures at each non-sharp vertex in the mesh model data;
creating, from the calculated principal curvatures, seed regions each being considered to belong to an analytic surface region and including a set of linked vertices;
determining, for each of the created seed regions, geometric parameters that define an analytic surface region according to the vertices of the seed region and fitting the analytic surface region to the seed region;
determining, for each of the created seed regions, whether or not each vertex that is in the vicinity of the seed region has allowable errors relative to the position and normal of the surface fitted to the seed region, adding the vertex to the seed region if the vertex has allowable errors to thereby grow the seed region, and extracting an analytic surface region representative of the grown seed region;
recognizing fillet surface regions, linear-extrusion surface regions and surface regions of revolution in the extracted analytic surface regions; and
outputting information concerning the extracted analytic surface regions and the recognized regions.

8. The method of claim 7, wherein finding sharp vertices and calculating principal curvatures comprise:
setting a parameter for determining a curvature evaluating range of each vertex twice as large as an average length of edges connected to the vertex;
calculating principal curvatures at the vertex;
classifying the vertex as a sharp vertex if a maximum principal curvature thereof is greater than the threshold;
setting a parameter for determining a curvature evaluating range of each non-sharp vertex five times as large as an average length of edges connected to the non-sharp vertex; and
calculating principal curvatures at the non-sharp vertex.

9. The method of claim 7, wherein creating seed regions comprises:
examining the calculated principal curvatures of each vertex and assigning to the vertex a label indicative of one selected from the group consisting of a plane surface, a cylindrical surface, a conical surface, a spherical surface and an optional surface to which the vertex belongs; and
extracting, as a seed region, a set of linked vertices having the same assigned label.

10. The method of claim 9, further comprising:
preparing, for vertices to which the optional surface label is assigned, a histogram with an abscissa representing principal curvatures and an ordinate representing the numbers of vertices and assigning a toric surface label to a group of vertices which have a predetermined principal curvature and whose number is greater than a threshold on the histogram.

11. The method of any one of claims 9 and 10, wherein determining geometric parameters that define an analytic surface region and fitting the analytic surface region comprise:
when fitting any one of a cylindrical surface and a conical surface to a seed region, fitting a plane to intersections between normals at vertices contained in the seed region and a Gaussian sphere and determining a normal of the plane as a direction of an axis;
for the cylindrical surface, projecting the vertices contained in the seed region to a plane that has a normal in the axis direction and crosses an origin, fitting a circular arc to the projected vertices, and finding a center of the circular arc and an arbitrary point on the axis; and
for the conical surface which satisfies a condition that a vector connecting the apex of the conical surface to each mesh vertex is orthogonal to a normal at the mesh vertex, calculating the apex of the conical surface according to the least square method and finding an apex angle according to an average of angles between the axis direction and the normals at the mesh vertices.

12. The method of any one of claims 9 and 10, wherein determining geometric parameters that define an analytic surface region and fitting the analytic surface region comprise:
when fitting a toric surface to a seed region, finding a direction of an axis and an arbitrary point on the axis, and according to the axis direction and arbitrary point, using the least square method to calculate a center, major radius and minor radius of the toric surface on condition that a minor-radius center is found by inwardly extending normals at mesh vertices for the minor radius and the major radius is found as a distance between the center and the minor-radius center.

13. A computer executable program for segmentation of mesh model data into analytic surfaces, comprising:
inputting mesh model data;
finding, in the mesh model data, sharp vertices each having a principal curvature (maximum principal curvature) greater than a threshold, excluding the sharp vertices, and calculating principal curvatures at each non-sharp vertex in the mesh model data;
creating, from the calculated principal curvatures, seed regions each being considered to belong to an analytic surface region and including a set of linked vertices;
determining, for each of the created seed regions, geometric parameters that define an analytic surface region according to the vertices of the seed region and fitting the analytic surface region to the seed region;
determining, for each of the created seed regions, whether or not each vertex that is in the vicinity of the seed region has allowable errors relative to the position and normal of the surface fitted to the seed region, adding the vertex to the seed region if the vertex has allowable errors to thereby grow the seed region, and extracting an analytic surface region representative of the grown seed region;
recognizing fillet surface regions, linear-extrusion surface regions and surface regions of revolution in the extracted analytic surface regions; and
outputting information concerning the extracted analytic surface regions and the recognized regions.

14. The computer executable program of claim 13, wherein finding sharp vertices and calculating principal curvatures comprise:
setting a parameter for determining a curvature evaluating range of each vertex twice as large as an average length of edges connected to the vertex;
calculating principal curvatures at the vertex;
classifying the vertex as a sharp vertex if a maximum principal curvature thereof is greater than the threshold;
setting a parameter for determining a curvature evaluating range of each non-sharp vertex five times as large as an average length of edges connected to the non-sharp vertex; and
calculating principal curvatures at the non-sharp vertex.

15. The computer executable program of claim 13, wherein creating seed regions comprises:
examining the calculated principal curvatures of each vertex and assigning to the vertex a label indicative of one selected from the group consisting of a plane surface, a cylindrical surface, a conical surface, a spherical surface and an optional surface to which the vertex belongs; and
extracting, as a seed region, a set of linked vertices having the same assigned label.

16. The computer executable program of claim 15, further comprising:
preparing, for vertices to which the optional surface label is assigned, a histogram with an abscissa representing principal curvatures and an ordinate representing the numbers of vertices and assigning a toric surface label to a group of vertices which have a predetermined principal curvature and whose number is greater than a threshold on the histogram.

17. The computer executable program of any one of claims 15 and 16, wherein determining geometric parameters that define an analytic surface region and fitting the analytic surface region comprise:
when fitting any one of a cylindrical surface and a conical surface to a seed region, fitting a plane to intersections between normals at vertices contained in the seed region and a Gaussian sphere and determining a normal of the plane as a direction of an axis;
for the cylindrical surface, projecting the vertices contained in the seed region to a plane that has a normal in the axis direction and crosses an origin, fitting a circular arc to the projected vertices, and finding a center of the circular arc and an arbitrary point on the axis; and
for the conical surface which satisfies a condition that a vector connecting the apex of the conical surface to each mesh vertex is orthogonal to a normal at the mesh vertex, calculating the apex of the conical surface according to the least square method and finding an apex angle according to an average of angles between the axis direction and the normals at the mesh vertices.

18. The computer executable program of any one of claims 15 and 16, wherein determining geometric parameters that define an analytic surface region and fitting the analytic surface region comprise:
when fitting a toric surface to a seed region, finding a direction of an axis and an arbitrary point on the axis, and according to the axis direction and arbitrary point, using the least square method to calculate a center, major radius and minor radius of the toric surface on condition that a minor-radius center is found by inwardly extending normals at mesh vertices for the minor radius and the major radius is found as a distance between the center and the minor-radius center.
